(19) United States
(12) Patent Application Publication
(10) Pub. No.: US 2002/0154154 A1
(43) Pub. Date: Oct. 24, 2002

(54) Methods and apparatus for providing localization of control panels

(76) Inventor: William L. Cornelius, Boise, ID (US)

Correspondence Address: HEWLETT-PACKARD COMPANY, Intellectual Property Administraion, P.O. Box 272400, Fort Collins, CO, 80527-2400, US

(21) Appl. No.: 09/839,822

(22) Filed: Apr. 20, 2001

(51) Int. Cl. G06F 3/00

(52) U.S. Cl. 345/705

(57) ABSTRACT

Methods and apparatus for allowing the user of a document processing apparatus to obtain local language descriptions of user input points. An apparatus in accordance with the present invention has a display, a processor, and a plurality of user-accessible input points configured to generate input point signals in response to being accessed by a user. An electronic readable memory device contains descriptions of at least some of the plurality of user-accessible input points. The descriptions are provided in a plurality of languages, including the desired local language. The local language is preselected from among the plurality of languages as the language to be made available to the user. The processor is configured to associate an input point signal with a corresponding description of the input point in the preselected language and to display the local language description of the user input point on the display.

### FIELD OF THE INVENTION

The invention claimed and disclosed herein pertains to user-accessible control panels, such as on office equipment, and to methods and apparatus for allowing the control panel to provide the user with localized descriptions of the control panel functions.

### BACKGROUND OF THE INVENTION

The present invention pertains use-accessible control panels, and particularly to such control panels as used on office equipment such as computer printers, photocopiers, facsimile machines, and so-called “all-in-one” machines. “All-in-one” machines typically combine the functions of a printer, a photocopier, a facsimile machine, and a document scanner in a single device. It is not uncommon for an all-in-one machine to have more than one user accessible control panel. All of these devices are typically provided with keypads allowing a user to select various functionality of the device. For example, an all-in-one device can have a keypad for entering telephones numbers for sending facsimiles, as well as keys allowing the contrast of copies to be varied, the number of copies to be varied, size reduction or enlargement of copies, and other features. Since these products are typically sold in various countries throughout the world the challenge becomes properly identifying the function of each button to all potential users. While in English speaking countries the buttons can be labeled in English, this is essentially of no help to users in a country where English is not the primary language.

One prior art solution is to provide local-language overlays for the keypads and control panels. The drawback to this solution is that it requires special parts (i.e., the overlays) to be designed, manufactured, and inventoried. Further, the manufacturer must ensure that the correct overlay is included with the device before the device is shipped to its destination country. Alternately, it requires someone at a local distribution center to inventory the overlays and to apply the overlay to the device before the product is shipped to the end-user. The use of overlays also adds another step to the manufacturing process (i.e., applying the overlay), or requires the user to apply the overlay when performing initial setup of the device. Requiring the end user to apply the overlay is undesirable since most purchasers of these devices expect them to be essentially fully assembled when the device is unpacked from the shipping carton. Another drawback to overlays is that if the device has more than one user interface or control panel, then an overlay needs to be provided for each interface and panel. Further, since most overlays are adhesive type overlays, the fascia of the control panel needs to be designed to accept an overlay, and the overlay needs to be designed so that it does not block indicators on the control panel, such as LEDs and the like.

An alternate solution is to label each key on the control panel with a generally recognized symbol which suggests the function of the key. While this may be practical for certain keys, such as the keys for increasing or decreasing the number of copies to be made, with other keys there is either no universally accepted symbol, or this is no acceptable symbol which might suggest the key's use. For example, a key which can be used to access speed dialing for sending a facsimile, or for allowing a facsimile to be sent directly from the scanner bed rather than via the document feeder, would be very difficult to represent.

A number of devices known in the art provide for screen displays which can be displayed in a selected language, and switched between one language and another. Such screen displays are particularly useful for process control machinery where it is important for an operator to see messages displayed by the controller in the operator's native language. Such devices are described for example in the following U.S. patents: U.S. Pat. No. 5,490,089 (Smith et al.) describes a knowledge-based control system which can display messages on a screen in different languages, as selected by a user; U.S. Pat. No. 5,526,268 (Tkacs et al.) describes an industrial process control system which can display process conditions on a screen in at least two languages, as selected by a user; U.S. Pat. No. 5,659,337 (Tanaka et al.) describes a programmable controller for a computerized numerical control (“CNC”) machine which can display messages in one of several preselected languages; U.S. Pat. No. 5,832,339 (Inui et al.) describes a photocopier with a display screen having touch keys and which can display the functions of the keys in two or more languages by selecting a language of choice; and U.S. Pat. No. 6,088,684 (Custy et al.) describes a printer for printing financial instruments, which allows a user to select a language for a touch-screen graphical user interface (GUI).

Many of the prior art solutions are directed towards providing a user with process control information, and not to the problem of providing the user with local language for a user interface. Those solutions which are specifically directed towards the problem of providing the user with local language for the user interface require the use of a touch screen which displays the functionality of the touch keys on a rather full screen display, such as a cathode ray tube (CRT), or a flat panel display (such as a liquid crystal display). Such displays can be expensive and increase the complexity of the device in which they are installed. While this may be acceptable in some applications, it is generally not practicable for devices intended for personal use or use in small offices. These latter devices can be considered as having what I will define as a “fixed” interface, versus what I term to be a “configurable” interface, such as a graphical user interface (“GUI”). A fixed interface is considered to have a plurality of user input points (such as push-buttons or capacitance type switches) which allow a user to select a function or vary a parameter of the device. None of the prior art solutions address the problem of describing the function of fixed interfaces in a local language.

What is needed then is a way to provide users of devices having fixed interfaces with a local language description of the function of the various user input points.

### SUMMARY OF THE INVENTION

The present invention provides methods and apparatus for allowing the user of a document processing apparatus to obtain local language descriptions of keys or buttons (“user input points”) associated with the document processing apparatus. One embodiment of the present invention is a document processing apparatus having a display and a plurality of user-accessible input points configured to generate input point signals in response to being accessed by the user. The apparatus also includes an electronic readable memory device containing descriptions of at least some of the plurality of user-accessible input points. The descriptions are provided in a plurality of languages, including the desired local language. The local language is preselected from among the plurality of languages as the language to be made available to the user. The apparatus further includes a processor configured to associate an input point signal from an input point with a corresponding description of the input point in the preselected language (i.e., the local language) and to display the local language description of the user input point on the display.

The apparatus of the first embodiment can be characterized by designating one of the user input points as a user assist input point. Then the corresponding local language description of this user assist input point comprises a message informing the user how to access descriptions for the remaining user-accessible input points. The apparatus can further include an access connection in communication with the processor. The access connection is configured to receive signals from an external access device to thus determine the preselected language.

An apparatus in accordance with a second embodiment of the present invention includes a document processing apparatus having a processor, a display, and a plurality of user-accessible input points configured to generate input point signals in response to being accessed by a user. The apparatus also has an electronic readable memory device comprising descriptions of selected ones of the plurality of user-accessible input points in a local language. The processor is configured to associate an input point signal from an input point with a corresponding description of the input point in the local language and to display the description on the display. The apparatus of the second embodiment differs from that of the first embodiment in that the apparatus of the first embodiment contains a the user input descriptions in a plurality of languages such that a desired language can be selected in a setup stage. The apparatus of the second embodiment does not contain a plurality of languages, but only the desired local language (or languages), which can be installed in the readable memory device during setup.

The current invention also provides a method for displaying local language descriptions of a plurality of user accessible input points of a document processing apparatus. The method includes the step of providing, on a machine readable medium and in the local language, a plurality of descriptions of user input points corresponding to the plurality of user accessible input points. Then, in response to a user accessing an input point, the local language description of the user input point which corresponds to the user input point is accessed, and the local language description of the user input point is displayed to the user. The local language description of the user input point can be displayed immediately, or only after the user has accessed the user input point for a predetermined period of time. Further, the method can include ceasing to display the description after another predetermined period of time.

The method can also include providing a plurality of descriptions of the user input points in a plurality of languages. The local language descriptions of the user input points are then selected as the descriptions to be accessed in response to a user accessing an input point. The method can further include designating a selected one of the user input points as a user assist input point. In this case, the description of the user assist input point includes instructions to the user for accessing descriptions of the remaining user input points.

These and other aspects and embodiments of the present invention will now be described in detail with reference to the accompanying drawings, wherein:

### DESCRIPTION OF THE DRAWINGS

FIG. 1 is an oblique drawing of a prior art “all-in-one” document processing apparatus which can use the present invention.

FIG. 2 is an oblique drawing of an “all-in-one” document processing apparatus which incorporates an embodiment of the present invention.

FIG. 3 is a schematic diagram showing one embodiment of an apparatus for implementing the present invention.

FIG. 4 depicts a flow chart of one method for using a “Help” key to implement an embodiment of the present invention.

FIGS. 5A and 5B in combination depict a flow chart of one method for generating a local language description of a key function in accordance with the present invention.

FIG. 6 depicts a flow chart of additional steps which can be added to the flowchart depicted in FIG. 5.

### DETAILED DESCRIPTION OF THE INVENTION

The present invention provides methods and apparatus which allow the user of a machine, such as an office machine, to access local language descriptions of buttons and switches used to operate the machine, without requiring the use of overlay devices or complex interactive displays screens. This also allows existing devices to be easily modified to provide local language capability. In essence, the present invention provides descriptions of the various keys or buttons in a variety of languages. These descriptions are stored in a computer or machine readable memory device in the apparatus. During setup of the apparatus for a local market, one of the languages is selected as the local language. Thereafter, when a user presses one of the keys or buttons in a manner intended to bring up the local language description of the key or button, a processor in the apparatus accesses the appropriate description and displays it to the user on a message display. I will now describe my invention in more detail.

The present invention pertains to any apparatus which includes a user interface or control panel comprised of buttons or keys and switches and the like which are used to access functionality of the apparatus. For example, a button can be used to toggle between two selections (e.g., “on-line” and “off-line”), or to scroll through a menu of choices (e.g., image size reduction consisting of 25%, 50%, 75%, 100%, 125%, 150%, or 200%). I will use the term “user accessible input points” or “user input point” or “input points” as generic terms to refer to such bottons and switches. When a user accesses an input point, it generates a signal, which I will term an “input point signal” or “input signal”, which can then be used by a processor resident within the apparatus to perform the designated function.

The present invention is particularly useful for office machines such as computer printers, photocopies, facsimile machines, “all-in-one” machines (which typically include the functionality of all of the preceding listed examples), and other similar machines. For the purposes of the following discussion, I will use the expression “document processing apparatus” to refer to any and all such machines, since the intended function of such machines is to process a document, either by way of printing a document or scanning the document for subsequent transmission of the scanned image to another device (such as a receiving facsimile machine).

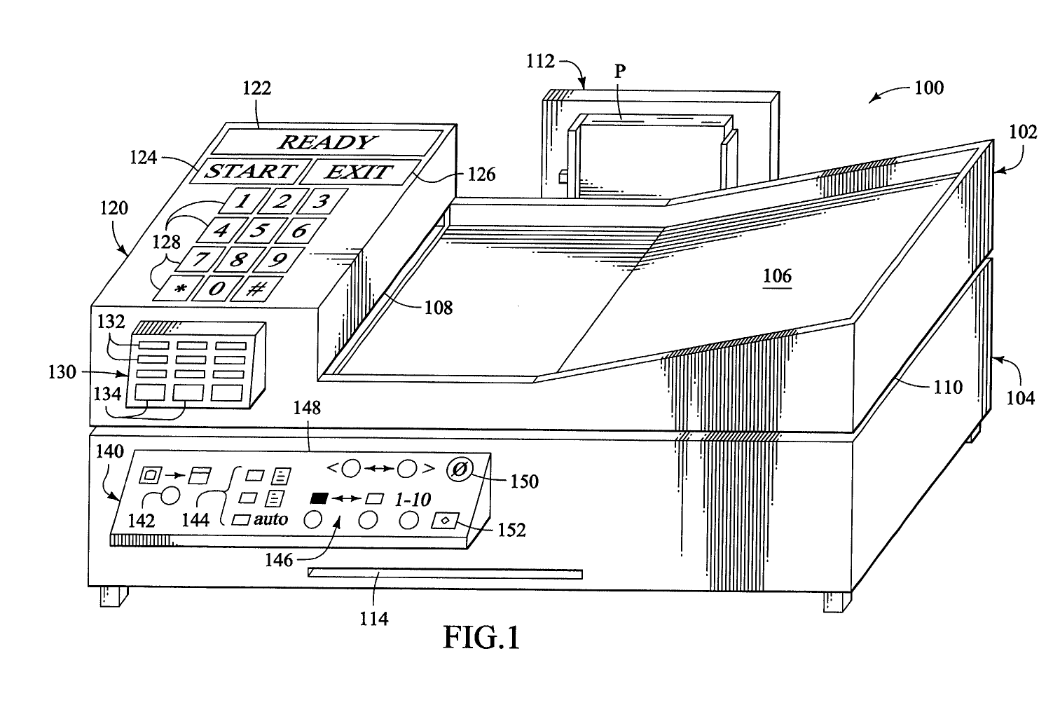

Referring now to FIG. 1, a prior art “all-in-one” type document processing apparatus 100 is depicted in an oblique view. This apparatus is the type of apparatus in which the methods and apparatus of the present invention can be used. It is understood that this apparatus is exemplary only, and that other document processing apparatus can also be used with the present invention. The apparatus 100 has an upper portion 102 which is hingedly connected to a lower portion 104 by hinges (not shown), allowing the upper portion to be opened with respect to the lower portion. The apparatus can include a document scanning bed 110 which is disposed in an upper portion of the lower component, and which can be accessed by rotating the upper portion 102 about the hinges, thus allowing documents to be placed directly on the scanning bed 110. The apparatus 100 also has a media feed tray 112 for holding sheets of blank media (such as paper “P”), upon which images can be printed by the apparatus.

The upper portion 102 of the apparatus 100 also includes a document feed tray 106 which can hold documents to be photocopied, faxed or scanned. A document feeder 108 can feed documents placed in the document feed try 106 into a scanner (not shown) contained within the upper portion 102. The lower portion 104 has a document discharge location 114 where printed or copied documents can be discharged, as well as copies of facsimiles received by the apparatus 100. One example of a document processing operation which can be performed by the apparatus is the photocopying of an original multi-page document. The original document is placed in the document feed tray 106. A user then instructs the apparatus 100 to make one or more copies of the document. The document is then fed, one page at a time, by the document feeder 108 past the scanner (not shown) in the upper portion 102. The scanned image of each page is then reproduced on a sheet of medium which is obtained from the media feed tray 112. The imaged copies of the original document sheets are then discharged at the document discharge location 114, where they can be accessed by the user.

The apparatus 100 further includes a display 122, as well as a plurality of user accessible input point stations or control panels 120, 130 and 140. The display 122 can be a dot matrix type liquid crystal display (LCD) configured to present text symbols from the ASCII format character set, and not having color capability or graphics display capability. The use of a display of this type reduces the complexity of the apparatus over using other types of displays, such as a color graphical user interface.

The input stations (control panels) 220, 230 and 240 essentially comprise groups of the different user input points, and are grouped according to their functional relationship. While some apparatus such as printers and copiers may only have a single input point station, the example shown in FIG. 1 has three such stations. The first input point station 120 can include a key pad containing user input points 128 for dialing a telephone number to send a facsimile. The first station 120 also has a “start” button to start sending a facsimile, as well as an “exit” button to clear numbers entered via the key pad. The second input point station 130 can include bottons or input points 132 for recalling telephone numbers which are stored in a computer readable memory resident within the apparatus 100, as well as input points 134 for entering deleting telephone numbers into and deleting them from the readable memory. The third input point station 140 can include user input points for document imaging, such as photocopying and the like. For example, input point 152 can start the copying process, input point 150 can stop the copying process, input points 146 can be used to lighten or darken the copied image, input points 144 can be used to select the image quality (for example, text, photograph, or automatic image adjustment), input points 148 can be used to increase or decrease the size of the resultant copied image, and input point 142 can be used to select between the scanner bed and a connected computer as the original document source.

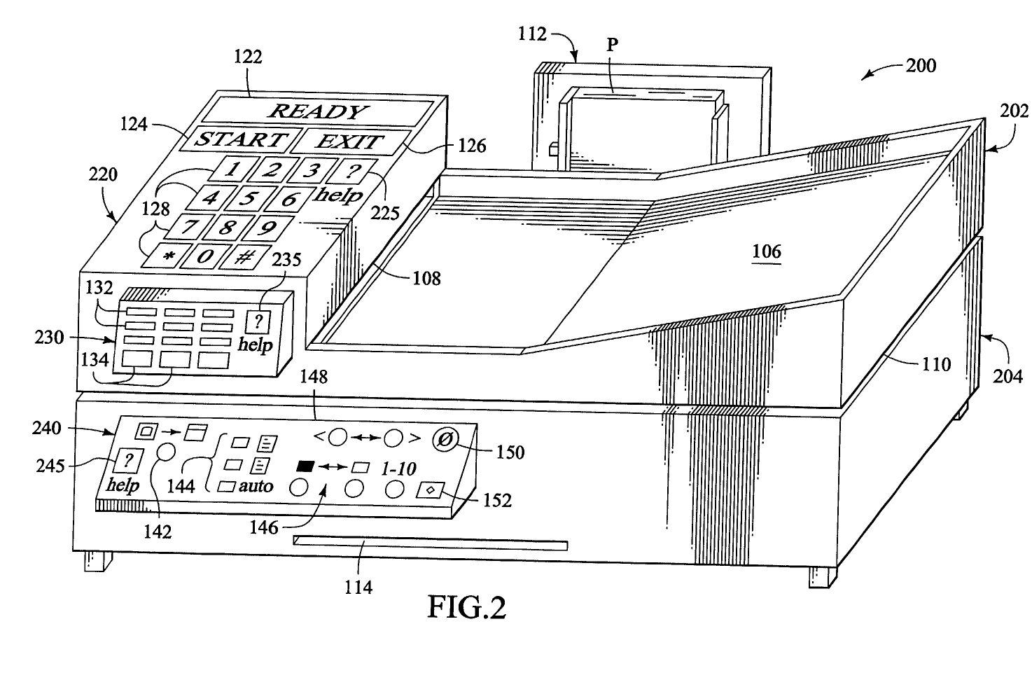

Turning now to FIG. 2, a document processing apparatus 200 in accordance with one embodiment of the present invention is depicted. The apparatus 200 is quite similar to the prior art apparatus 100 of FIG. 1 in many respects, and particularly in outward appearance. All of the components identified in FIG. 2 by reference numerals which are the same as those for components in identified and described for FIG. 1 have the same function and purpose, and so will not be redescribed here. However, the apparatus 200 differs from the apparatus 100 in the following respects. The upper portion 202 of apparatus 200 contains a modified first user input station 220 which includes a first user assist input point 225, which can also be described as a “Help” key. In like manner, the lower portion 204 of the apparatus 200 has a modified second user input station 230 which includes a second user assist input point 235, and a modified third user input station 240 having a third user assist input point 245. The user assist input points 225, 235 and 245 can all be identified by a question mark “?”, and/or the word “Help”. The function of the user assist input points will be discussed further below. The apparatus 200 further differs from the apparatus 100 in the manner in which input points are processed by the resident processor, as will now be described.

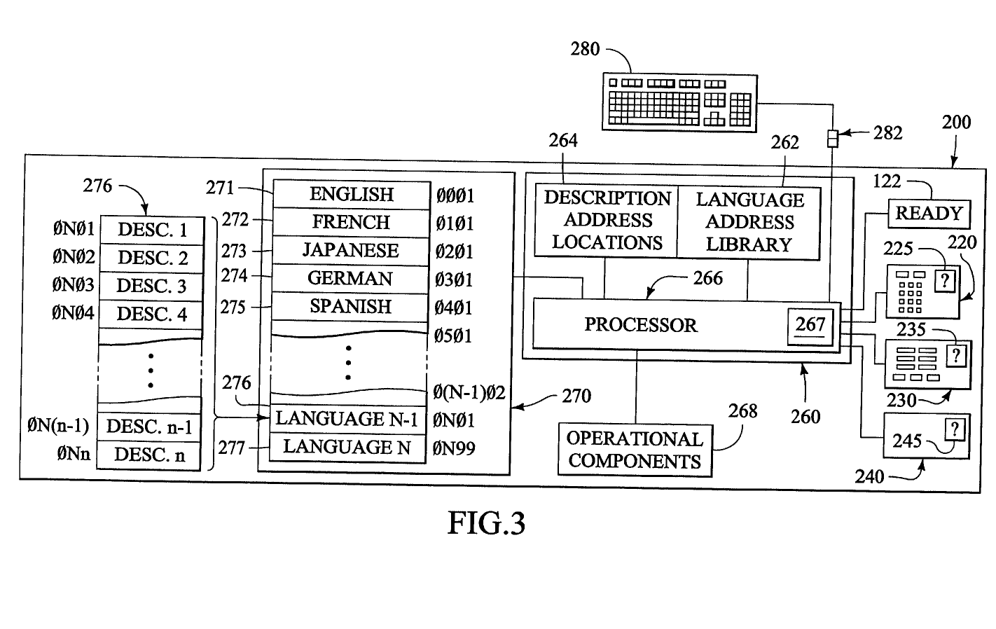

With reference to FIG. 3, a schematic diagram of one embodiment of the present invention which can be used in the apparatus 200 of FIG. 2 is depicted. The apparatus 200 of FIG. 3 includes the three user input stations 220, 230 and 240, as described above. Each input station includes a respective user assist input point 225, 235 and 245, also as described above. The three user input stations are connected to a processor 266, which is part of the local language description processor 260. In addition to performing the local language description functions to be described below, the processor 266 can also perform other functions pertaining to the operational components 268 of the apparatus 200. For example, the processor can configure a bit stream received by the apparatus from an external computer into a raster image to then be printed by the apparatus 200. One example of a processor which can be used in the apparatus of the present invention is a microprocessor which can execute a series of computer executable steps which are stored in a computer readable memory.

The apparatus 200 further includes an electronic readable memory device 270, which can be a computer readable memory. The memory 270 can be, for example, a read only memory (ROM) microchip. In addition to storing other operating parameters for the apparatus, the memory device contains descriptions of selected ones of the user accessible input points from the user accessible input point stations 220, 230 and 240. While the memory can contain descriptions of all of the user input points, this may not be necessary for certain keys such as the number keys 128 in the key pad 220. The descriptions of the user input points are stored in the memory 270 in a plurality of languages. For example: a list of the selected descriptions in English can be stored in memory section 271, comprised of memory address locations 0001 through 0100; descriptions in French can be stored in memory section 272, comprised of memory address locations 0101 through 0200; descriptions in Japanese can be stored in memory section 273, comprised of memory address locations 0201 through 0300; descriptions in German can be stored in memory section 274, comprised of memory address locations 0301 through 0400; and descriptions in Spanish can be stored in memory section 275, comprised of memory address locations 0401 through 0500. As many descriptions in as many different languages as are desired can be stored in the memory by providing sufficient memory capacity. In the example shown, “N” languages are stored in the memory 270, with the descriptions in the penultimate language “N−1” being stored in memory section 276, comprised of memory address locations 0(N−1)01 through 0N00, and the descriptions in language “N” being stored in memory section 277, comprised of memory address locations 0(N−1)01 through 0N99.

Each of the memory sections 271 through 277 will contain the descriptions for the user input points which have been identified to have descriptions associated therewith, but in different languages. For example, for language “N−1”, the list of descriptions is “Description 1” contained at memory location 0N01, “Description 2” contained at memory location 0N02, “Description 3” contained at memory location 0N03, “Description 4” contained at memory location 0N04, the penultimate description “Description (n−1)” contained at memory location 0N(n−1), and the last description “Description n” contained at memory location 0Nn. Preferably, each of the lists of descriptions in each language correspond to one another. For example, if Description 1 is, “Use this key to start copying”, then this message is stored in English in memory location 0001, in German at memory location 0301, and in language “N−1” at memory location 0N01.

The apparatus 200 can further include a language address library 262, which comprises a stored listing of the available languages and the memory address locations associated with each of the plurality of languages. Preferably, the language address library is stored in a read only memory device, and can be the memory device 270.

During manufacture of the apparatus 200, the memory device 270, and the language address library 262, are installed in the apparatus. Preferably the memory device 270 is a ROM microchip, but it can also be a readable medium such as a compact disk (CD), a hard drive, or other known electronic readable devices. The memory device 270 preferably includes all anticipated languages which will be encountered in the different markets in which the apparatus is sold. Preferably, before the apparatus 200 is delivered to an end user, the anticipated local language is selected so that the end user does not have to perform this step. For example, at a local country distribution center, a technician can connect an external access device 280 (such as a keyboard) to an access connection 282, which can be the input connection used to connect the apparatus to an external computer by the end user. The technician can then access the language address library 262 and can identify and select the memory locations corresponding to the local language descriptions of the user input points. These selected memory locations can then be stored in a description address location memory 264. For example, if the language selected is French, then the addresses of memory locations 0101 through 0200 are stored in the description address location memory 264. Preferably, memory 264 comprises a non-volatile memory device, such as a programable read only memory device, such that the memory address locations for the selected local language will not be lost when electrical power is not provided to the apparatus 200.

In one variation on the apparatus 200 depicted in FIG. 3, the memory device 270 includes only the language of the anticipated local language, and the language address library 262 memory is not required, nor is the description address location memory 264. However, this requires that a large number of memory devices 270 be manufactured (one for each anticipated language), and so it is preferably to provide a plurality of different languages on the memory device 270. Also, the apparatus can be configured with a blank, programmable memory device 270, and then during the set up stage the person performing the setup of the apparatus can access the desired local language descriptions of the input points from external software, and can program the memory device with the local language descriptions. Additionally, the selection or installation of the local language input point descriptions can be selected or installed by the end user, although this is less preferable to providing a fully configured apparatus to the end user.

The operation of the apparatus to provide to a user a local language description of a selected user input point will now be described. Preferably, each of the input points is identified to the user by a corresponding marking in proximity to the input point, either on a panel adjacent to the input point, or on the input point itself. For example, the button which is used to start the photocopying of an original document can be identified by the symbol [symbol] , or the English word “Start”. If the marking is insufficient for the user to identify the function of the input point, then the user can access the local language description of the input point. This can be accomplished in several ways.

In a first example, if the user accesses the user input point (e.g., presses the button or key which is the input point) for more than a predetermined period of time, the processor determines that the user desires the local language description of that particular user input point, accesses the local language description associated with the user input point from the memory device 270 (using the description address location memory 264), and displays the local language description on the display 122. After a preselected duration of time, the description can cease to be displayed. More specifically, the apparatus 200 can include an electronic timer 267. In response to an input point being accessed by a user, the input point generates an input point signal for a duration of time equal to the time the input point is accessed. The electronic timer measures the duration of time the input point is accessed, and, when a preselected duration of time is measured by the timer (for example, 2 seconds), the processor thereafter associates the input point signal with the corresponding description of the input point in the preselected local language. That is, after the preselected duration of time has lapsed, the processor locates the local language description associated with the input point being accessed, and displays the message. The processor locates the correct description which is stored in the memory device 270 by using the description address locations stored in memory 264. If the input point is accessed for less than the preselected duration of time, then the processor implements the functional aspects assigned to the input point, rather than displaying the local language description of the input point.

The electronic timer 267 can also be used to time the duration of time that a description of a user input point is displayed by the display 122. That is, the timer 267 begins to measure time once a local language description of a user input point is displayed. After a preselected duration of time the processor 266 ceases to display the description. The processor can also be configured with a program interrupt step which causes the displaying of the user input point description to cease if another user input point is accessed by the user prior to the expiration of the preselected duration of time. Alternately, or in addition to using the electronic timer 267, the processor 266 can be configured such that it continues to display the description of the user input point so long as the particular user input point continues to be accessed by the user, and ceases the display of the description when the user ceases to access the user input point.

When the apparatus 200 is provided with user assist input points 225, 235 and 245, then, in response to a user accessing one of these user assist input points, the processor can access and display a message informing the user how to access descriptions of the other user-accessible input points. For example, each user assist input point can cause the processor to retrieve from the memory device 270, and to display in the display 122, a local language equivalent of the message, “To see description of keys, press and hold key.” The message can also be tailored to be particular to the group of input points which is associated with the specific user assist in put point. For example, if the user assist point 225 in the telephone dialing keypad 220 for sending a facsimile is accessed, the message which is displayed can be the local language equivalent of, “Use keys in this area to send a facsimile. For functions of specific keys, press and hold the key.” However, it is understood that a separate user assist point does not need to be associated with each group of user input points, and that a single user assist input point can be provided even when there are a plurality of input point groups.

Further, when the apparatus 200 is provided with user assist input points 225, 235 and 245, then, in response to a user simultaneously accessing one of these user assist input points and another user input point, the processor can access and display the local language description of the second input point (i.e., the input point which is not the user assist input point). For example, if a user simultaneously accesses the user assist input point 225 and key 124 (the “Start”key in the facsimile sending section 220), then the processor can retrieve from the memory device 270, and display via display 122, the local language equivalent of, “Press this key to start sending a facsimile.” When this feature is provided, the processor can be further configured such that the normally assigned functionality of an input point is not provided to the user until both the user assist input point and the second input point are no longer being accesses by the user. Further, the processor can be configured to cease displaying the message as soon as one or both of the user input points are released (i.e., no longer accessed by the user). In this way the user can access the description of the input point for as long as he or she desired, merely by continuing to hold down both the user assist input point and the second input point.

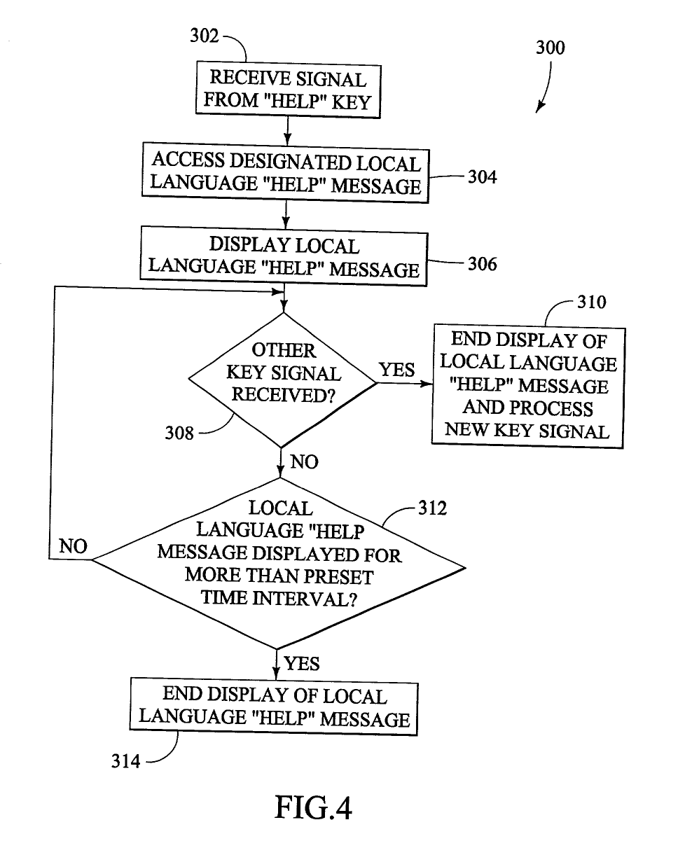

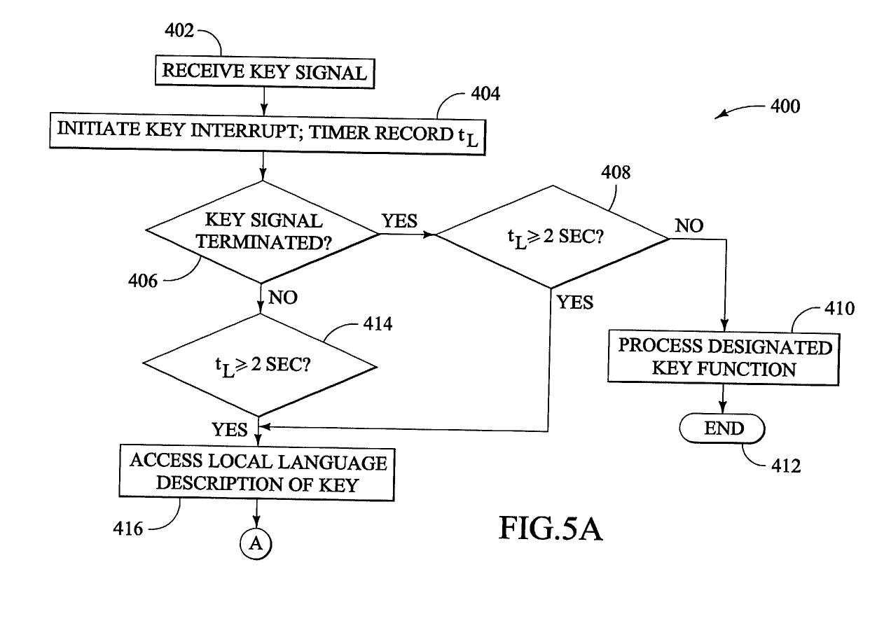

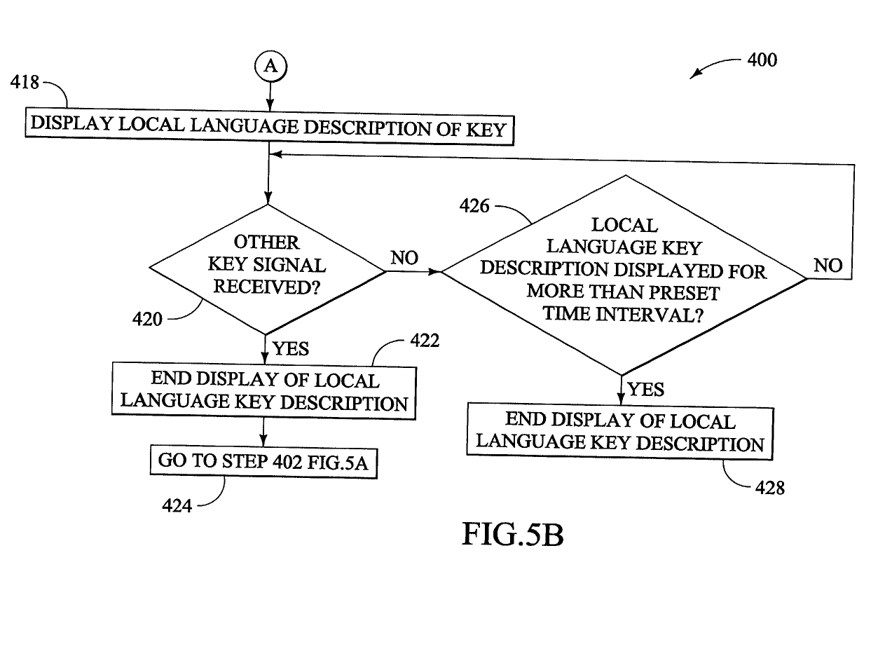

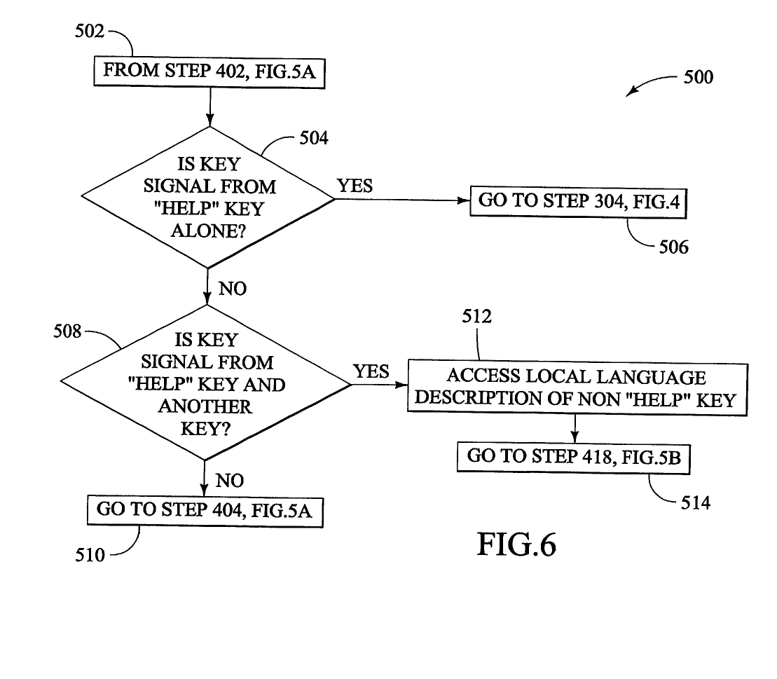

Turning now to FIG. 4, a flow chart 300 is depicted which can be used to implement the method of the present invention using the apparatus 200 of FIGS. 2 and 3. The flowchart 300 shows how a user assist key (user assist input point) such as 225, 235 or 245 can be used by itself to provide a local language message to the user telling the user how to obtain information relating to the use and functions of the other keys (user input points). The steps of the flow chart can be implemented as a set of computer readable instructions (a “program”), which can be stored in a memory device (such as memory device 270), accessed by the processor in response to receiving user input point signals, and executed. The following description of flow chart 300 will also make reference to the apparatus and components shown in FIGS. 2 and 3, above.

At step 302 of FIG. 4 the processor (266 of FIG. 3) receives a unique signal generated by a user accessing the user assist input point (“Help” key 225, for example). In response to receiving this unique signal, the processor accesses the description address locations 264 and looks up the memory location where the message or description associated with the unique signal is located. The processor then accesses this memory location in memory device 270, and retrieves the local language “help” message associated with the particular user assist input point (step 304). The processor then displays this local language “help” message via the display 122 (step 306). Once the message is displayed, the electronic timer 267 is activated by the processor 266 to time the duration during which the message is displayed. If, at step 308, a signal for a different user input point (i.e., an input point other than the user assist point originally selected) is received by the processor 266, then the processor ceases to display the local language “help” message, and processes the new user input signal. However, if no new signal is received, then the processor checks the duration of display of the current “help” message (as measured by the timer 267), and checks at step 312 to determine whether the predetermined display time has been met. If so, at step 314 the display of the “help” message is terminated. If not, control returns to step 308, where the processor again checks to determine whether a new input signal has been received.

Turning now to FIGS. 5A and 5B, a flow chart 400 is depicted which can be used to implement the method of the present invention using an apparatus similar to the apparatus 200 of FIGS. 2 and 3, but without user assist input points (225, 235 and 245). Generally, the method comprises displaying the user input point description after the user point has been accessed by the user for a predetermined period of time. As with the flow chart 300 of FIG. 4, the steps of the flow chart 400 of FIGS. 5A and 5B can be implemented as a set of computer readable instructions (a “program”), which can be stored in a memory device (such as memory device 270), accessed by the processor in response to receiving user input point signals, and executed.

The process described by the flow chart 400 begins at step 402 of FIG. 5A, wherein the processor (266 of FIG. 3) receives a unique signal generated by a user accessing a user input point (a “key”). Receipt of this signal by the processor initiates a key interrupt (step 404), which starts the electronic timer (267 of FIG. 3). The electronic timer records the elapsed time t_{L} since the user input point was first accessed. (If the elapsed time exceeds a preselected time interval, then the description of the key will be displayed, as described further below.) At step 406 the processor polls it input ports to determine if the input signal from the input point has been terminated. If so, then at step 408 the processor checks to determine whether the elapsed time t_{L}, as measured by the electronic timer, has exceeded the preselected time interval (for example, 2 seconds). If not, then at step 410 the processor implements the normally assigned functionality of the key. For example, if the user input point accessed was the “start copy” key, and the key was accessed for less than the preselected time interval (here, 2 seconds), then at step 410 the processor would initiate the processor of photocopying a document. However, if the user input point was accessed for more than the preselected interval of time, then from step 408 the processor moves to step 416 to begin the process for displaying a local language description of the user input point.

At step 406, if the signal from the input point has not terminated, then at step 414 the processor checks to determine whether the elapsed time t_{L}, as measured by the electronic timer, has exceeded the preselected time interval (for example, 2 seconds). If not, then the processor again returns to step 406 to determine if the input signal is still being received. If at step 414 the preselected time interval has been met or exceeded, then the processor moves to step 416 to begin the process for displaying a local language description of the user input point.

To paraphrase the last two paragraphs, the processor is configured to only display the local language description of the key if the key has been accessed continuously for 2 or more seconds (steps 408 and 414). However, if the signal terminates before 2 seconds, then the processor implements the normally assigned functionality of the key (step 410). However, if the signal has not terminated, but the time interval has not yet been reached, then nothing happens.

Moving now to step 416, the process for displaying the local language description of the user input point begins. Based on the unique signal generated by the user input point being accessed and received by the processor 266, the processor the accesses the description address locations 264 and looks up the memory location where the description associated with the signal is located. The processor then accesses this memory location in memory device 270, and retrieves the local language description of the input point. The processor then displays this local language description of the input point via the display 122 (step 418, FIG. 5B). At step 420 (FIG. 5B), the processor polls it input ports to determine if another input point signal has been received. If so, at step 422 the local language description of the input point is terminated, and control returns to step 402 (FIG. 5A) so that the processor can process the new signal. However, if no new signal is received, at step 426 (FIG. 5B) the processor checks to determine whether the description has been displayed for more than a preset time interval. (This preset time interval can be measured by the electronic timer 267 of FIG. 3 since the timer is previously released following step 414 of FIG. 5A.) If the preset time interval (for example, 4 seconds) has been met or exceeded, then at step 428 (FIG. 5B) the display of the local language description of the user input point is terminated. However, if the preset time interval has not yet been met, then the processor continues to display the description, and returns to step 420 to poll for a new input signal.

The processes described above for flow charts 300 and 400 can be combined so that the process just described for flow chart 400 can further include the benefits of a user assist input point (a “Help” key). This can be accomplished by inserting into the flow chart 400 of FIGS. 5A and 5B the additional steps shown in flow chart 500 of FIG. 6. Specifically, following step 402 of flow chart 400 (FIG. 5A), the processor 266 determines at step 504 whether the user input point being accessed is a user assist input point. This can be determined based on the unique signal generated by the user input point and received by the processor. If the signal received by the processor is solely from a user assist input point, then at step506 the processor moves to step 304 of flow chart 300, and proceeds to process the input signal in the manner shown therein and described above to display the local language “help” message. However, if the signal is not solely from a user assist input point, then at step 508 the processor checks to determine whether the signal is from a user assist input point in conjunction with a signal from another user input point. Such a situation corresponds to a user simultaneously accessing both a user assist input point and a second input point to thereby immediately access the description of the second input point. If the processor determines that this is the case, then the processor moves to step 512 and immediately accesses the local language description for the second key, in the manner described above, and continues thereafter beginning at step 418 of FIG. 5B. However, if no user assist input key signal has been received, then the processor moves to step 404 of FIG. 5A and continues the sequence described above with respect to steps 404 et seq.

It is understood that flow charts 300, 400 and 500 are exemplary only, and that other sequences for displaying the local language description of a key and a “help” message can also be provided to equal effect.

The invention further includes a method for displaying local language descriptions of a plurality of user accessible input points of a document processing apparatus. The method includes providing, on a machine readable medium and in the local language, a plurality of descriptions of user input points corresponding to the plurality of user accessible input points. This step can correspond to storing the local language descriptions for the input points to be described in selected memory locations of the memory device 270 of FIG. 3, wherein the memory device 270 acts as the machine readable medium. In response to a user accessing an input point, the local language description of the user input point which corresponds to the user input point is accessed. The local language description of the input point is then displaying to the user. The last two steps can be implemented by steps 416 and 418 of flow chart 400 (FIGS. 5A and 5B, respectively), in the manner described above.

The method can further include providing a plurality of descriptions of the user input points in a plurality of languages. This can be performed as described above for the various languages shown stored in memory device 270 of FIG. 3. When a plurality of languages are provided, the method includes the step of selecting the local language descriptions of the user input points as descriptions to be accessed in response to a user accessing an input point. This can be accomplished by using a description address location memory, such as item 264 of FIG. 3.

The method can also include displaying the local language description of the user input point only after the user has accessed the user input point for a predetermined period of time. An example of this step is described at steps 408 and 414 of FIG. 5A, using a timer such as electronic timer 267 of FIG. 3. The method can further comprise ceasing to display to the user the local language description of the user input point after a predetermined period of time. An example of this is shown at steps 426 and 428 of FIG. 5B, using the electronic timer 267 of FIG. 3.

Yet another feature that can be included in the method is designating a selected one of the user input points as a user assist input point. For example, input points 225, 235 and 245 of FIG. 2 can be designated as “user assist input points”. When user assist input points are provided for, the local language description associated with the user assist input point can be instructions to the user for accessing descriptions of the remaining user input points. An example of this is shown by flow chart 300 (FIG. 4). Further, the method can be modified such that when a user simultaneously accesses a user assist input point and a second user input point, the description displayed is the local language description of the second user input point. (See steps 508, 512 and 514 of FIG. 6, for example.)

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A document processing apparatus comprising:
a display;
a plurality of user-accessible input points configured to generate input point signals in response to being accessed by a user;
an electronic readable memory device comprising descriptions of selected ones of the plurality of user-accessible input points in a plurality of languages; and
a processor configured to associate an input point signal from an input point with a corresponding description of the input point in a preselected one of the plurality of languages and to display the description on the display.

2. The apparatus of claim 1, and further wherein the display is configured to display the description in a dot matrix text format.

3. The apparatus of claim 1, and wherein:
the electronic readable memory device is characterized by memory address locations;
descriptions of the user-accessible input points are associated with selected memory address locations;
the memory address locations of the preselected language are stored in a separate description memory address location; and
the processor is configured to associate the descriptions of the input points by accessing the description memory address location.

4. The apparatus of claim 3, and further comprising an access connection in communication with the processor, the access connection configured to receive signals from an external access device to thereby store the memory address locations of the preselected language in the separate description memory address location, and wherein the external access device does not comprise part of the document processing apparatus, and further wherein the memory address locations of the preselected language can only be stored in the separate description memory address location by the external access device.

5. The apparatus of claim 1, and further comprising an electronic timer, and wherein:
in response to being accessed by a user, an input point generates the input point signal for a duration of time equal to the time the input point is accessed;
the electronic timer is configured to measure the duration of time the input point is accessed;
and, the processor is further configured to associate the input point signal with the corresponding description of the input point in the preselected language when a preselected duration of time is measured by the timer.

6. The apparatus of claim 1, and wherein one of the selected ones of the user input points comprises a user assist input point, and wherein the corresponding description of the user assist input point in the preselected language is a message informing the user how to access descriptions of the remaining selected ones of the plurality of user-accessible input points.

7. The apparatus of claim 6, and further wherein the processor is configured such that, when the user assist input point and one of the remaining selected ones of the input points are simultaneously accessed by a user, the description in the preselected language which is displayed by the processor is the description of the one of the remaining selected ones of the input points.

8. The apparatus of claim 1, and further comprising an electronic timer, and wherein the electronic timer is configured to measure the duration of time the description of the input point is displayed, and the processor is further configured to stop the display of the description when a preselected duration of time is measured by the timer.

9. The apparatus of claim 1, and further comprising an access connection in communication with the processor, the access connection configured to receive signals from an external access device to thereby determine the preselected language.

10. The apparatus of claim 1, and wherein the selected ones of the user input points are defined by a first group of user input points and a second group of user input points, and wherein the first group of user input points comprises a first user assist input point, the second group of user input points comprises a second user assist input point, and wherein the corresponding description of the first user assist input point in the preselected language is a message particular to the first group of user input points, and the corresponding description of the second user assist input point in the preselected language is a message particular to the second group of user input points.

11. A method for displaying local language descriptions of a plurality of user accessible input points of a document processing apparatus, comprising:
providing, on a machine readable medium and in the local language, a plurality of descriptions of user input points corresponding to the plurality of user accessible input points; and
in response to a user accessing an input point, accessing the local language description of the user input point which corresponds to the user input point, and displaying to the user the local language description of the user input point.

12. The method of claim 11, and further comprising providing a plurality of descriptions of the user input points in a plurality of languages; and
selecting the local language descriptions of the user input points as descriptions to be accessed in response to a user accessing an input point.

13. The method of claim 11, and wherein the local language description of the user input point is only displayed after the user has accessed the user input point for a predetermined period of time.

14. The method of claim 11, and further comprising ceasing to display to the user the local language description of the user input point after a predetermined period of time.

15. The method of claim 11, and further comprising ceasing to display to the user the local language description of the user input point when the user accesses another user input point.

16. The method of claim 11, and further comprising:
designating a selected one of the user input points as a user assist input point; and
wherein the description of the user assist input point comprises instructions to the user for accessing descriptions of the remaining user input points.

17. The method of claim 16, and wherein, when a user input point other than the user assist input point is accessed by the user, the local language description of the user input point is displayed only after the user has accessed the user input point for a predetermined period of time, and when a user simultaneously accesses the user assist input point and a second user input point, the description displayed is the local language description of the second user input point.

18. A document processing apparatus comprising:
a display;
a plurality of user-accessible input points configured to generate input point signals in response to being accessed by a user;
an electronic readable memory device comprising descriptions of selected ones of the plurality of user-accessible input points in a local language; and
a processor configured to associate an input point signal from an input point with a corresponding description of the input point in the local language and to display the description on the display.

19. The apparatus of claim 18, and wherein each of the selected ones of the user input points are identified to the user by a corresponding marking in proximity to the associated user input point, and wherein the markings are not local language descriptions of the user input points.

20. The apparatus of claim 18, and wherein one of the selected ones of the user input points comprises a user assist input point, and wherein the corresponding description of the user assist input point in the local language is a message informing the user how to access local language descriptions of the remaining selected ones of the plurality of user-accessible input points.
